(19) United States
(12) Patent Application Publication
(10) Pub. No.: US 2004/0055798 A1
(43) Pub. Date: Mar. 25, 2004

(54) Motor vehicle assembly

(76) Inventor: Jens Arik Almkermann, Isenbuttel (DE)

Correspondence Address: Peter N. Lalos, Kenneth J. Whittington,, Stevens, Davis, Miller & Mosher, LLP, 1615 L Street, N.W., Suite 850, Washington, DC, 20036-5622, US

(21) Appl. No.: 10/621,615

(22) Filed: Jul. 18, 2003

(30) Foreign Application Priority Data
Jul. 19, 2002 (DE) DE 102 32 737.8

(51) Int. Cl. H01M 8/04; B60L 11/18; B60K 6/00

(52) U.S. Cl. 180/65.2; 429/26; 429/20; 429/24; 180/65.3

(57) ABSTRACT

(The invention relates to a motor vehicle assembly (1) having an internal combustion engine (2), an exhaust gas treatment system (3) associated with the latter, and a fuel cell system (4). Provision is made such that the fuel cell system (4) is thermally coupled to the internal combustion engine (2) and/or to the exhaust gas treatment system (3).

The invention relates to a motor vehicle assembly having an internal combustion engine, an exhaust gas treatment system associated with it, and a fuel cell system.

A motor vehicle assembly of the type referred to here is of the state of the art. It is used for propulsion and on-vehicle electric power supply of a motor vehicle. The motor vehicle assembly has an internal combustion engine unit which consists of an internal combustion engine and an exhaust gas treatment system cleaning the engine exhaust gases mounted downstream from it and which usually performs the function of propelling the motor vehicle. The motor vehicle assembly also has a fuel cell system. The fuel cell system, also designated as auxiliary power unit (APU), is suited in particular for on-vehicle electric power supply, since it promotes energy efficiency more than does a conventional generator powered by an internal combustion engine. Use of APUs is thus to be recommended precisely in vehicles with a large electric power requirement, such as luxury-class vehicles and their large number of current-consuming devices. The fuel cell system may, however, also be used as a propulsion unit, as is the case in hybrid vehicles, for example, in which the fuel cell system forms an additional propulsion unit for the internal combustion engine, and thus permits fuel conserving motor vehicle propulsion. Despite the advantages indicated in the foregoing, undesirable pollutant emissions which are caused essentially by the internal combustion engine occur in the case of the motor vehicle assembly in question during operation, in particular during the cold start phase.

The invention is accordingly based on the problem of providing a motor vehicle assembly of the type indicated in the foregoing, one in which the discharge of undesirable pollutants is very low. It is claimed for the invention that the problem is solved in that the fuel cell system is thermally coupled to the internal combustion engine and/or the exhaust gas system. Heat exchange between the fuel cell system and the internal combustion engine and/or between the fuel cell system and the exhaust gas treatment system may be effected by system of thermal coupling. If the temperature level in the fuel cell system is higher than in the internal combustion engine or in the exhaust gas treatment system, a thermal flux from fuel cell system to internal combustion engine or to the exhaust gas treatment system occurs which results in heating of the internal combustion engine or of the exhaust gas treatment system. A thermal flux such as this is favorable if the internal combustion engine and the exhaust gas treatment system is/are in the cold start phase or a cold running phase, that is, is/are operating at a temperature lower than the operating temperature, since the operating temperature may be reached more rapidly and accordingly the dwell time in the cold start or cold running phase is reduced. As a result, pollutant emissions, which are intensified by an internal combustion engine not running at operating temperature and cannot be eliminated to a sufficient extent by the exhaust gas treatment system, for example, because the exhaust gas treatment system as well is not operating at the operating temperature, can be largely prevented. Consequently, the thermal coupling provides the possibility of delivering heat to the processes taking place in the internal combustion engine and in the exhaust gas treatment system and accordingly of reducing to a minimum undesirable effects such as formation and emission of pollutants. In principle, it is also possible for a thermal flux to occur as a result of the thermal coupling, for example, from the internal combustion engine or from the exhaust gas treatment system to the fuel cell system, specifically, if the temperature level of the fuel cell system is lower than that of the internal combustion engine or the exhaust gas treatment system.

The fuel cell system preferably is thermally coupled to the intake area of the internal combustion engine, especially the air intake, and/or the engine coolant circuit of the internal combustion engine. Heating of the intake tract may be effected by system of thermal coupling of the fuel cell system to the intake area of the internal combustion engine. It is possible in this way to preheat the fuel delivered to the internal combustion engine by way of the intake area so that efficiency increasing and emission reducing effects are achieved for the combustion process. If the intake area involved is an air intake area, the air conducted in it may be preheated in this area. If the intake area involved is a fuel delivery area, the fuel for the internal combustion engine may be heated in this area. In the case of internal combustion engines with suction pipe injection, heating of the intake area results in reduced formation of fuel wall film in the cold running or cold start phase of the internal combustion engine, that is, the formation of an undesirable fuel film on the walls of the internal combustion engine, which formation is intensified during the operating phase, is largely prevented. As an alternative or in addition, the fuel cell system may be coupled to the engine cooling cycle so that in this way thermal coupling to all the areas of the engine housing conducting coolant is possible. If the operating temperature of the internal combustion engine has not yet been reached, very rapid heating of the engine housing may take place as a result of thermal coupling to the engine circulation.

One development of the invention provides that the fuel cell system be thermally coupled to an exhaust gas recycling system of the internal combustion engine. The exhaust gas recycling system preferably is an internal exhaust gas recycling system of the internal combustion engine, that is, the engine housing already has channels by way of which the exhaust gas is recycled, after or simultaneously with discharge from the combustion chamber, to the feed area of the combustion chamber and is then delivered again to the combustion chamber. Thermal coupling of the fuel cell system to the exhaust gas recycling system may be effected as an alternative or in addition to coupling of the fuel cell system to the intake area or the engine coolant circulation.

One development of the invention provides that the thermal coupling may be configured so that it may be engaged and disengaged. The thermal coupling may accordingly be intentionally engaged or activated specifically when the systems to be coupled are in desired operating states or in desired operating phases. Since undesirable pollutant formation occurs in particular when the internal combustion engine and/or the exhaust gas treatment system is/are not operating at the operating temperature, provision is made such that the thermal coupling takes place only during the cold start phase of the internal combustion engine or the cold start phase of the exhaust gas treatment system. Delivery of heat from the fuel cell system during the cold start phase is possible, since the fuel cell system reaches operating temperature very rapidly. It is possible to determine the duration of the thermal coupling on the basis of the system with the longer cold start phase. If the internal combustion engine has a cold start phase longer than that of the exhaust gas treatment system, the thermal coupling may be configured on the basis of the cold start phase of the internal combustion engine. In the opposite case the duration of the thermal coupling may be configured on the basis of the cold start phase of the exhaust gas treatment system, or both the internal combustion engine and the exhaust gas treatment system may be taken into account.

Provision is made such that the thermal coupling is effected by way of at least one medium. The medium is at least one gas, at least one liquid, and/or at least one solid. A plurality of media, in particular media in different states of aggregation, may also be used for heat transfer. Consequently, heat transfer by system of one gas and one solid is just as possible as by system of one liquid and one solid. The heat transfer may be effected by system of thermal conduction, thermal convection, and/or thermal radiation. The media or the different states of aggregation may be combined as desired.

The thermal coupling preferably is effected by system of at least one heat exchanger. The heat exchanger may be a gas/liquid heat exchanger, a gas/solid heat exchanger, a liquid/solid heat exchanger, a gas/gas heat exchanger, a liquid/liquid heat exchanger, or a solid/solid heat exchanger. In addition, a plurality of these heat exchangers may be combined in order to effect thermal coupling of the fuel cell system to the internal combustion engine and/or the exhaust gas treatment system.

In one development of the invention provision is made such that the fuel cell system has a heat dissipation system and such that the thermal coupling is connected to the heat dissipation system, preferably by way of at least one branch connection. The heat dissipation system of the fuel cell system preferably conducts a heating medium which is connected to the air intake area, the engine circulation of the internal combustion engine, and/or the exhaust gas treatment system or is delivered to at least one of the systems referred to. Heat may accordingly be dissipated from the heat dissipation system by way of a minimum of one connection. A gaseous or liquid medium may be employed as heating medium. Hence it is possible in a first alternative for the heat dissipation system to conduct a hot gas as heating medium and for the hot gas to be dissipated from the heat dissipation system by way of the branch connection to the exhaust gas treatment system and to be delivered directly to these systems by way of a junction mounted on the internal combustion engine or on the exhaust gas treatment system. Direct delivery is to be understood here to mean that the hot gas is delivered to and mixed with the combustion air (air intake). If the junction is mounted in the air intake area, the combustion air is heated by system of the hot gas and a mixture of combustion air and heated gas is formed which is introduced into the combustion process. If the junction is mounted on the exhaust gas recycling system, the exhaust gas is heated by system of the heated gas, the heated gas being mixed with the exhaust gas and being delivered as a hot gas-exhaust mixture by way of the exhaust gas recycling system to the internal combustion engine and accordingly to the combustion process. Exhaust gas recycling by system of a hot gas-exhaust mixture is to be given preference over exhaust gas recycling by system of exhaust gas in that, because of the presence of oxidizable components in the hot gas, the exhaust gas-hot gas mixture additionally has an oxidizable potential or reduction potential for the combustion process. The same applies to delivery of an exhaust gas-hot gas mixture to the exhaust gas treatment system. If the exhaust gas treatment system is an oxidation device, the hot gas may improve the oxidation process both because of its heat and because of its oxidizable components. In a second alternative a liquid heating medium may be conducted to the heat dissipation system rather than hot gas as heating medium and be fed from this system by system of the branch. In this instance the junction may be mounted on the engine circulation of the internal combustion engine, so that the liquid heating medium is fed directly into the engine circulation and mixed there with the coolant. This results in very rapid heating of the entire area in the engine housing through which coolant is conducted.

By preference provision may be made such that the heat dissipation system is designed as a coolant circulation system and such that the coolant circulation system and the engine coolant circulation system form a common coolant circulation system. The coolant circulation system of the heat dissipation system and the engine coolant circulation system are in this instance virtually coupled to each other, so that heat losses are prevented by intermediate heat exchangers or feeder lines between the heat dissipation system and the engine coolant circulation system.

In one advantageous embodiment provision is made such that a reformer, a minimum of one gas cleaning system and/or a minimum of one fuel cell, are associated with the heat dissipation system. Association of the reformer with the heat dissipation system is especially advantageous. The reformer has, for example, a thermally relevant mass smaller than that of the fuel cell. The reformer consequently has the capability of making very hot gas available during the cold start phase. Especially in the event of use of the reforming product made by the reformer do the broad temperature range in which the reforming product may be present (400° C. to 900° C.) and the wide spread of concentrations of individual reformer components, such as high H2/CO2 or high CH4 percentages, as required, prove to be especially advantageous with respect to optimal reduction of pollutant emissions, in that optimal adjustment may be made of the thermal coupling with respect to reduction of pollutant emissions over the wide range of adjustability of reforming production emissions. However, association of additional or other devices of the fuel cell system with the heat dissipation system is also immediately possible. In this situation, selective oxidation reactor or water-gas shift stages of the gas cleaning devices, for example, may be coupled to the heat dissipation system. Combination of the associated devices of the fuel cell system associated with the heat dissipation system depends on the respective temperature levels to be reached by thermal coupling and the reduction potentials desired—in the case of direct delivery of hot gas with oxidizable components—in the combustion processes of the internal combustion engine and/or the exhaust gas recycling system.

In one development a control unit is provided which includes the cold start phase and which engages the thermal coupling when the cold start phase is present. Specific engagement of the thermal coupling during the cold start phase may be effected by the control unit. This may be accomplished, for example, in that the control unit monitors the operating condition of the fuel cell or of the heat dissipation system and engages the thermal coupling when an adequate heat level is present. If the thermal coupling is provided at several points of the internal combustion engine and thermal coupling to the exhaust gas treatment system is provided, the control unit may perform a sort of assignment management in that the control unit registers the heat or temperature level at a given coupling point by system of heat or temperature registers at the coupling points and effects heat delivery meeting the respective heat requirement.

Provision is preferably made such that the thermal coupling is disengaged by system of the control unit when the cold start phase is not present. Thermal reflux from the internal combustion engine and the exhaust gas treatment system to the fuel cell system may be prevented if the temperature level of the internal combustion engine or the exhaust gas treatment system is higher than that of the fuel cell system when the operating temperature of the internal combustion engine or of the exhaust gas treatment system is reached.

Other advantageous embodiments are obtained with combinations of the characteristics specified in the dependent claims.

The invention is explained in greater detail through the example of several exemplary embodiments, with reference to the drawings, in which

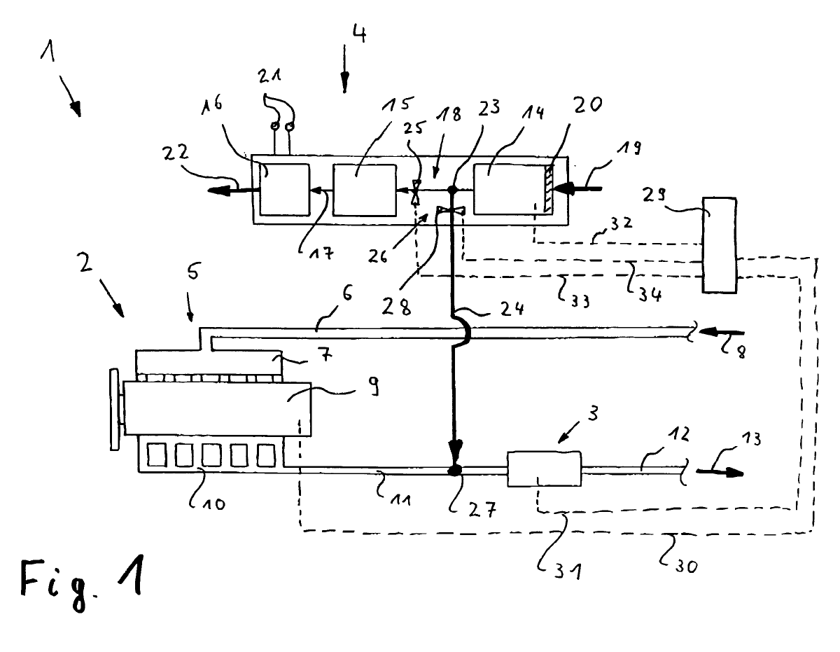

FIG. 1 shows a motor vehicle assembly in a first exemplary embodiment;

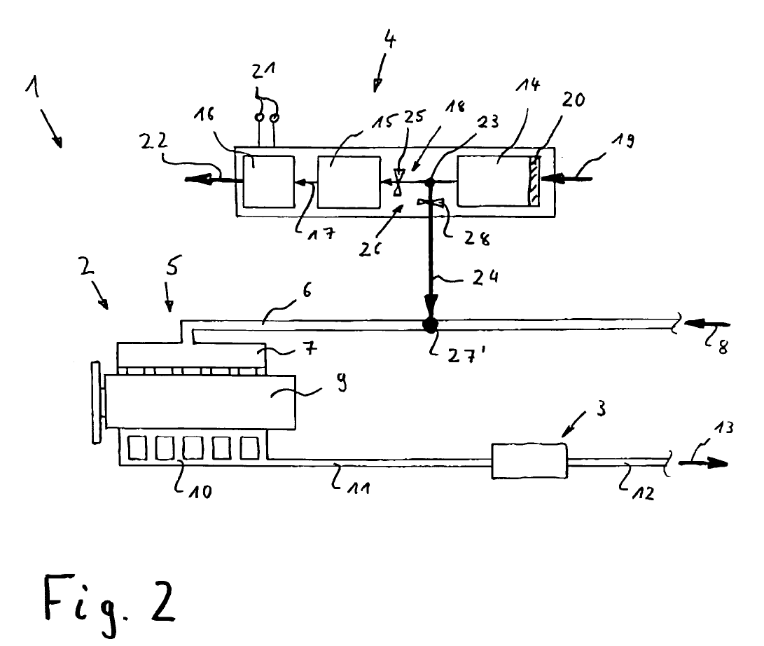

FIG. 2 the motor vehicle assembly shown in FIG. 1 in a second exemplary embodiment;

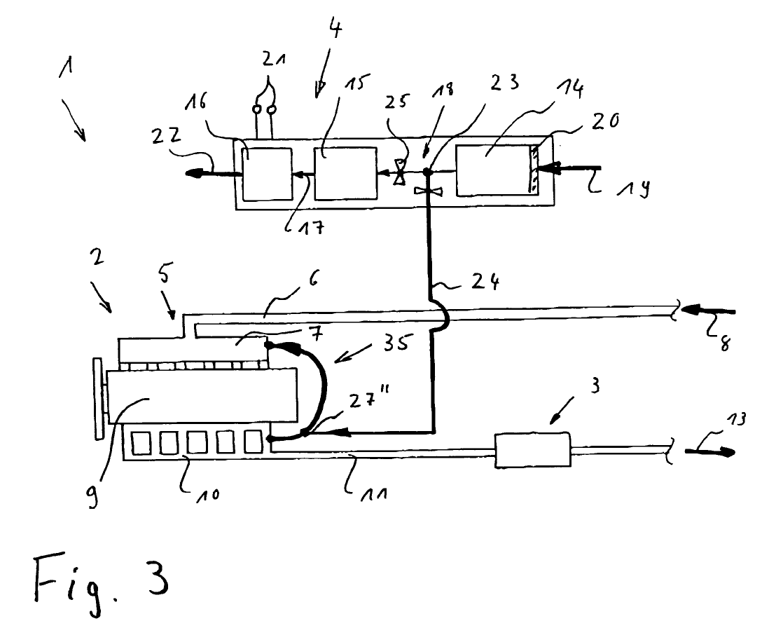

FIG. 3 the motor vehicle assembly shown in FIG. 1 in a third exemplary embodiment; and

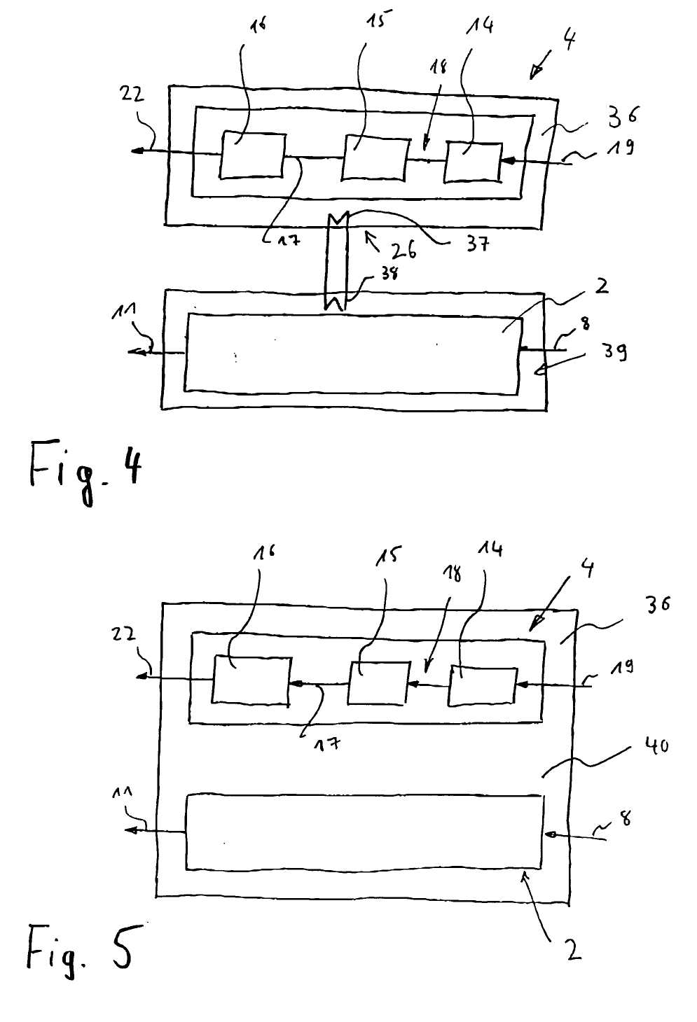

FIG. 4, exemplary embodiments of a thermal coupling of a fuel cell system FIG. 5 to an internal combustion engine.

FIG. 1 presents in diagram form a motor vehicle assembly 1 having an internal combustion engine 2, an exhaust gas treatment system 3 mounted downstream from the internal combustion engine 2, and a fuel cell system 4. The internal combustion engine 2 comprises an intake area for fuel (not shown in FIG. 5) and an air intake area 5, which contains an air line 6 and an intake tract 7. The air line 6 and the intake tract 7 are mounted relative to each other so that combustion air 8 flows over the air line 6 into the intake tract 7 and from this point reaches the combustion chamber 9. The internal combustion engine 2 also has an exhaust gas collector 10 which is connected by an exhaust gas line 11, the exhaust gas line 11 discharging into the exhaust gas treatment system 3. The outlet of the exhaust gas treatment system 3 is connected to a second exhaust gas line 12 through which the exhaust gas leaves the motor vehicle assembly 1 in the direction of arrow 13. The exhaust gas treatment system 3 may be in the form of an oxidation catalyst, redox catalyst, or the like. The configuration and design of the internal combustion engine 2 and the exhaust gas treatment system 6 as described in the foregoing are of the state of the art and accordingly will not be described in greater detail.

The fuel cell system 4 comprises a reformer 14, a gas cleaning system 15, and a fuel cell 16. The gas cleaning system 15 is in the form of a selective oxidation reactor. The gas cleaning system 15 may be a water-gas shift stage or a combination of a selective oxidation reactor and a water-gas shift stage rather than a selective oxidation reactor. All common types may be used as a fuel cell, but by preference high-temperature membrane fuel cells (HTPEMFC) or other high-temperature systems are provided. The fuel cell 16 may also be in the form of a solid oxide fuel cell (SOFC). The fuel cell 16 is connected to the gas cleaning system 15 by a fuel cell fuel line 17, the gas cleaning system 15 in turn being connected to the reformer 14 by a reforming product line 18. The flow of material shown in FIG. 1 is as follows: A fuel 19 is fed to the reformer 14 by way of a catalyst 20 (E-Kat). A reformer gas (reforming product) is produced in the reformer 14 which is fed to the gas cleaning system 15 by way of the reforming product line 18. In the gas cleaning system 15 the reforming product undergoes preparation such that the concentration of reforming product components such as carbon monoxide (CO) is reduced so that a cleaned, water-free fuel is fed to the fuel cell 16, fuel from which electric energy is generated which may be carried off by way of the connections 21. In addition, exhaust gas is produced which is removed from the fuel cell system 4 in the direction indicated by the arrow 22. The configuration of the fuel cell system 4 as described in the foregoing is of the state of the art and accordingly will not be further discussed.

In the exemplary embodiment of the motor vehicle assembly 1 presented in FIG. 1 there is provided in the reforming product line 18 a branch line 23 by way of which hot reforming product from the fuel cell system 4 may be removed by way of withdrawal line 24. A shutoff valve 25 is also provided in the reforming product line between the branch line 23 and the gas cleaning system. The shutoff valve 25, the branch line 23, and the gas cleaning system 15 are components of a heat dissipation system 26 of the fuel cell system 4. The withdrawal line 24 is connected by a junction 27 to the first exhaust gas line 11. A control unit 29 is also provided which is connected by way of sensor signal lines 30, 31 to temperature sensors or heat registration sensors (not shown in FIG. 1). The control unit is also connected by a sensor signal line 32 to the reformer 14. In addition, connection to the first shutoff valve 24 and the second shutoff valve 28 by way of control lines 33, 34 is provided.

The device operates as follows. When the motor vehicle assembly 1 is switched on, the internal combustion engine 2, the exhaust gas treatment system 3, and the fuel cell system 4 are started. In this startup phase the first shutoff valve 25 and the second shutoff valve 28 are closed, so that reforming product cannot flow into the gas cleaning system 15 and the first exhaust gas line 11. The control unit 29, which controls the operating condition both in the internal combustion engine 2, the exhaust gas treatment system 3, and the reformer 14, opens the second shutoff valve 28 when the reforming product of the reformer 14 is at a predetermined temperature and its gas is of a predetermined composition. Appropriate sensors are provided in the reformer 14 and accordingly in the lines conducting reforming product (not shown in FIG. 1) for registration of the reforming product temperature. The composition of the gas may also be registered by system of appropriate gas sensors or empirically determined characteristic curves which describe the composition of the reforming product gas as a function of the temperature of the reformer 14. When the second shutoff valve 28 is open, the reforming product flows by way of the withdrawal line 24 and the junction 27 into the first exhaust gas line 11 and is mixed there with the exhaust gas coming from the internal combustion engine 2 to form an exhaust gas-reforming product mixture. The exhaust gas-reforming product mixture is fed by way of the first exhaust gas line 11 into the exhaust gas treatment system 3. Heating takes place in the exhaust gas treatment system 3 as a result of the heat carried in the exhaust gas-reforming product mixture, as does also secondary oxidation of the oxidizable components still contained in the exhaust gas-reforming product mixture. Since the reforming product has a large energy portion in the form of convected heat and unburnt oxidizable components, accelerated heating occurs as a result of additional introduction of reforming product into the exhaust gas treatment system 3. The thermal coupling described here of the fuel cell system 4 to the exhaust gas treatment system 3 continues as long as the exhaust gas treatment system 3 is kept at operating temperature, that is, so long as the exhaust gas treatment system 3 associated with reduced performance has not yet completed its cold start phase. When the exhaust gas treatment system 3 reaches the operating temperature, the first shutoff valve 25 and the second shutoff valve 28 are actuated by way of the control unit 29, in such a way that the second shutoff valve 28 is closed so that there is no longer thermal coupling of the fuel cell system 4 to the exhaust gas treatment system 3 and the first shutoff valve 25 is opened, so that hot reforming product may now flow into the gas cleaning system. It is also possible, of course, for the first shutoff valve 25 to be partly or fully opened before the cold start phase of the exhaust gas treatment system 3 has ended, so that only partial streams of the reforming product may flow into the exhaust gas treatment system 3. Suitable other gradations of the extent of opening of the first shutoff valve 25 or of the second shutoff valve 28 are also possible.

FIG. 2 illustrates another exemplary embodiment of the motor vehicle assembly 1. Systems and components already described with reference to preceding FIG. 1 are provided with reference numbers, so that to this extent reference is made to their description in the foregoing. Only the differences are discussed in detail in what follows. The fuel cell system 4 is thermally coupled to the air intake area 5, in this instance in particular to the air line 6 of the air intake area 5. There is provided in the air line 6 for this purpose a junction 27′ which is connected to the withdrawal line 24 of the heat dissipation system 26, so that heat may be delivered by way of the hot gas of the reformer 14 of the fuel cell system 4 to the air intake area 5 of the internal combustion engine 2. The thermal coupling and the reforming product supply of the fuel cell 16 are engaged and disengaged in this exemplary embodiment by a process similar to that in the exemplary embodiment shown in FIG. 1, by system of the control unit 29 and the first shutoff valve 25 and the second shutoff valve 28. The control unit 29 and the sensor signal lines 30, 31, 32 and the control lines 33 and 34 are for the sake of simplification not shown in FIG. 2. The cold running of the internal combustion engine, which usually occurs during the cold start phase, may be reduced by delivery of hot gas, by system of the thermal coupling of the fuel cell system 5, to the air intake area of the internal combustion engine 2. Since the reformer 14 is capable of preparing very hot gas very rapidly, it is advantageous to mix the hot gas directly with the intake air at a very early point in time. Heating of the intake air 8 during the cold running phase prevents formation of a film of fuel on the still cold walls of the housing of the internal combustion engine 2. Thermal coupling of the fuel cell system 4 to the air intake area 5 thus effects reduction in cold start emissions as a result of prevention of formation of a wall film of fuel; in addition, the cold start emissions are reduced by the shorter cold running phase of the internal combustion engine. Thermal coupling may also be effected in the intake tract 7 or at another point of the air intake area 5. Heating of the combustion air 8 or of the air intake area 5 by system of at least one heat exchanger is also possible. It is important that the air intake area 5 and the combustion area conducted in it be heated; the temperature of the fuel and the components through which the fuel is conducted before entering the combustion chamber 9 is also raised by such heating.

Thermal coupling of the fuel cell system 4 to the intake tract 7 or the air intake area 5 on the basis of the exemplary embodiment shown in FIG. 3 is also possible as an alternative to the thermal coupling illustrated in FIG. 2. In the exemplary embodiment shown in FIG. 3 the internal combustion engine 2 has an exhaust gas return line 35 in the form of the interior exhaust gas return line of the internal combustion engine 2, this being indicated by the arrow 35. Systems and components which have already been described with reference to the preceding figures are provided with the same reference numbers and will not be described again. This applies also to the control unit 29 not shown in FIG. 3 and to the sensor signal lines 30, 31, 32 and to the control lines 33, 34, which are not shown. In the embodiment shown in FIG. 3 a junction 27″ is provided on the exhaust gas return line 35. The junction 27″ is connected to the reformer 14 of the fuel cell system 4 by way of the withdrawal line 24. Especially during the cold start phase of the internal combustion engine 2 the exhaust gas is additionally heated by thermal coupling to the fuel cell system 4 and is returned to the intake tract 7 of the internal combustion engine 2 by way of the exhaust gas return line 35. The delivery to the intake tract 7 of the internal combustion engine has the effect of preventing formation of pollutant emissions especially during the cold start phase of the internal combustion engine. In addition, formation of a film of fuel on the wall in the area of the intake tract during the cold running phase of the internal combustion engine is reduced.

FIG. 4 presents a diagram of the fuel cell system 4 the heat dissipation system 26 of which is in the form of coolant circuit 36. The heat dissipation system 26 also has a heat exchanger 37. The reformer 14, the gas cleaning system 15, and the fuel cell are associated with the heat dissipation system 26, the systems in question being mounted as shown in the embodiments of the fuel cell system 4 in FIGS. 1 to 3. The first heat exchanger 37 is connected to a second heat exchanger 38, the second heat exchanger 38 being mounted in the engine coolant circuit 39 of the internal combustion engine 2. Heat from the fuel cell system 4 is transmitted by way of the first heat exchanger 37 of the heat dissipation system 26 or to a medium (water or gas) in the heat exchanger 3 and to the second heat exchanger 38, where heat is transmitted from the medium to the coolant in the engine coolant circuit 39.

FIG. 5 presents a diagram of a configuration of the fuel cell system 4 and the internal combustion engine 2 in which the coolant circuit 36 of the heat dissipation system 26 and the engine coolant circuit of the internal combustion engine 2 are in the form of a common coolant circuit 40. Thermal coupling between the fuel cell system 4 and the internal combustion engine 2 is effected in this exemplary embodiment so that heat transfer is made by one and the same heating medium. Losses resulting from use of additional heat exchangers are thus prevented.

It remains to be said in recapitulation that the options described of thermal coupling between a fuel cell system and an internal combustion engine and/or an exhaust gas treatment system, especially during the cold start phase or during cold running of the internal combustion engine and the exhaust gas treatment system are advantageous. The exhaust gas treatment system can be brought rapidly to operating temperature by system of the thermal coupling. In addition, by system of the thermal coupling the cold running phase of the internal combustion engine can be shortened and, especially in the case of internal combustion engines with suction pipe injection, formation of fuel film on the walls in the cold running phase can be prevented. The ultimate result of all these measures is that the formation of pollutant emissions is reduced during the cold start phase of the motor vehicle assembly.

1. A motor vehicle assembly having an internal combustion engine, an exhaust gas treatment system associated with it, and fuel cell system, characterized in that the fuel cell system (4) is thermally coupled to the internal combustion engine (7) and/or the exhaust gas treatment system (3).

2. A motor vehicle assembly as specified in claim 1, wherein the fuel cell system (4) is thermally coupled to the intake area of the internal combustion engine (2), the air intake area (5) in particular, and/or the engine coolant circuit (39) of the internal combustion engine.

3. A motor vehicle assembly as specified in one of the preceding claims, wherein the fuel cell system (4) is thermally coupled to an exhaust gas return line (35) of the internal combustion engine (2).

4. A motor vehicle assembly as specified in one of the preceding claims, wherein the exhaust gas return line (35) is an internal exhaust gas return line of the internal combustion engine (2).

5. A motor vehicle assembly as specified in one of the preceding claims, wherein the thermal coupling is designed so that it may be engaged and disengaged.

6. A motor vehicle assembly as specified in one of the preceding claims, wherein the thermal coupling is available only during the cold start phase of the internal combustion engine (2) or the cold start phase of the exhaust gas treatment system (3).

7. A motor vehicle assembly as specified in one of the preceding claims, wherein the thermal coupling is effected by way of at least one medium.

8. A motor vehicle assembly as specified in one of the preceding claims, wherein the medium is at least one gas, at least one liquid, and/or at least one solid.

9. A motor vehicle assembly as specified in one of the preceding claims, wherein the thermal coupling is effected by system of at least one heat exchanger (37, 38).

10. A motor vehicle assembly as specified in one of the preceding claims, wherein the fuel cell system (4) has a heat dissipation system (26) and wherein the thermal coupling is connected to the heat dissipation system (26), preferably by way of at least one branch line (23).

11. A motor vehicle assembly as specified in one of the preceding claims, wherein the heat dissipation system (26) of the fuel cell system (4) conducts a hot medium, wherein the hot medium is coupled to the air intake area (5), the exhaust gas return line (35), and/or the exhaust gas treatment system (3) or is delivered to at least one of the systems specified in the foregoing.

12. A motor vehicle assembly as specified in one of the preceding claims, wherein the heat dissipation system (26) is in the form of a coolant circuit (36) and wherein the coolant circuit (36) and the engine coolant circuit (39) have a common coolant circuit (40).

13. A motor vehicle assembly as specified in one of the preceding claims, wherein there is associated with the heat dissipation system (26) at least one reformer (14), at least one gas cleaning system (15), and/or at least one fuel cell (16).

14. A motor vehicle assembly as specified in one of the preceding claims, characterized by a control unit (29) which covers the cold start phase and which engages the thermal coupling when the cold start phase is present.

15. A motor vehicle assembly as specified in one of the preceding claims, wherein the thermal coupling is disengaged by system of the control unit (29) when the cold start phase is not present.
